(19) United States
(12) Patent Application Publication
(10) Pub. No.: US 2015/0296721 A1
(43) Pub. Date: Oct. 22, 2015

(54) Methods and Apparatus for Affecting an Atmospheric Cyclone

(71) Applicant: Allen M. BISSELL, Chevy Chase, MD (US)

(72) Inventor: Allen M Bissell, Virginia Beach, VA (US)

(21) Appl. No.: 14/650,005

(22) PCT Filed: Dec. 10, 2013
(86) PCT No.: PCT/US2013/074120

§ 371 Date: Jun. 5, 2015

Related U.S. Application Data
(60) Provisional application No. 61/735,435, filed on Dec. 10, 2012.

(51) Int. Cl. A01G 15/00; G01W 1/10; G01W 1/02

(52) U.S. Cl. CPC A01G 15/00; G01W 1/02; G01W 1/10

(57) ABSTRACT

Methods and apparatus for affecting atmospheric cyclones and quantifying parameters related to affected cyclones are disclosed. These methods and apparatus involve attacking a cyclone chemically, without the use of explosives, with an energy transfer inhibitor that can interfere with the transmission of energy from the sea surface to the cyclone. The energy transfer inhibitor, if properly chosen and placed in a desired path of the storm, can deny one part of the storm energy from the latent heat of vaporization of water, thereby creating an imbalance in the centrifugal force of the cyclone. The imbalance can reduce the intensity of the cyclone and can be used to steer the storm. Quantifying parameters associated with an affected cyclone enables forecasting the cyclone's energy state, path, intensity, or other related parameters and evaluating possible additional energy transfer inhibitor distribution.

### TECHNICAL FIELD

This invention relates to methods and apparatus for affecting an atmospheric cyclone and quantifying parameters related to an affected atmospheric cyclone.

### BACKGROUND

The United States southern and eastern coast regions have historically experienced hurricane encroachment upon the mainland that has resulted in massive property destruction, loss of life, extreme coastal erosions, and severe economic dislocations. With Hurricanes Isaac and Sandy in 2012, the need to find a way to keep these storms away from coastal areas has reached critical status.

Due to a warming climate, increased evaporation of the planet can lead to an increase in atmospheric humidity and an increase in the prevalence of cyclones. Cyclone formation can involve tropical low pressure areas that increase evaporation while cooling the earth's surface and creating a humid atmosphere. Cyclone formation can also involve subtropical air masses encountering warm air from the south that mixes with cold air from the north. These unstable humid atmospheres are rich with water vapor and the energy of the latent heat of vaporization of water.

Air currents carrying humid surface air can organize into cyclones. Wind shear can form at the interfaces of countervailing winds, which can produce centers of rotation. Centrifugal force created by these centers of rotation can create an area of low pressure, by pulling mass from the center of rotation which, in turn, can produce vortexes. These vortexes can rotate and reach down to the sea surface, forming water spouts and can gain sufficient mass angular momentum to rapidly grow and organize into a larger depression. Once contact is made with the sea, the effect can be to seal off the interior of the vortex from the local atmospheric pressure so that a vacuum is created. This low pressure center can pull the surrounding air/water/entrained mass mixture toward the vortex, decreasing the radius of gyration about the center, which increases the rotational velocity sufficiently to form an eye. This can be one way in which a local depression can grow into a full-fledged cyclone.

A cyclone can extract energy during the phase transition when water vapor is condensed into rain. In other words:

E=ΔHᵥₐₚ×m

Where E is energy in joules, ΔHᵥₐₚ is the latent heat of vaporization of water in joules/mole, and m is the mass of water in moles. Thus, the power available to a cyclone during the course of the storm can be enormous. Consider a Category 1 fully developed hurricane proceeding at sea at 5 knots (11.11 km/h), the core of which occupies a space covering a 1000 square mile seascape and extending up 5000 feet. Considering that the hurricane can evaporate 200 pounds of water per second per square mile, 1000 square miles would yield 200,000 pounds per second with each pound of water liberating 970.7 BTU. The power of such a storm is: (200,000 lbs/sec)×(970.3 BTU/lb)×(778 ft-lbs/BTU)×(1 HP/550 ft-lbs/sec)×(0.000745699872 megawatts/1 HP)=204,699.6 megawatts.

The energy extracted through the condensation of water can then be dissipated, for example, through the force of the storm acting on the sea surface to create waves or by driving the air and water vapor mixture around the eye of the storm. Sustained waves can radiate out from the eye for hundreds of miles. These waves can create an enormous storm surge which can be pushed ashore. Even though a hurricane may only be classified as a Category 1, it can easily lift a storm surge many feet above sea level, 14 feet in the case of Hurricane Sandy at the New York Battery Park, flooding Ellis Island and causing widespread flood damage.

The cooling effect upon the surface waters subjected to the storm's passage is enormous. For example, consider the cyclone that can evaporate 200,000 lbs of water per second (90,718.47 kg/sec) from the 1000 square mile (2589.99 km²) core seascape. Assume the seawater temperature to be 75 degrees Fahrenheit (297.04 K) at the surface and extending down 1 foot (0.30 m) below the surface. For each second the cyclone evaporates water from the surface, the cooling effect on 1000 square miles (2589.99 km²) seascape is:
(200,000 lbs/sec)×(970.7 BTU/lb)=204,751.59 mJ/sec or
194,140 BTU per second per square mile or 194,140/(5280×5280) BTU per square foot per second=0.00696381 BTU per cubic foot per second or 259.421594 J/m³ per second
   Thus, a storm moving at 6 mph (9.656 km/hr) passing over the ocean for 10 hours can cool each cubic foot of water by 0.00696381×36000 =250.697 BTU or 3.893 BTU per lb. of seawater. Considering the specific heat of seawater, a cyclone can lower the temperature of a pound of seawater by about 4.14 degrees Fahrenheit (2.2 degrees Celsius). The temperature of the ocean left in the storm's wake would drop from 75 degrees Fahrenheit (23.9 degrees Celsius) to about 71 degrees Fahrenheit (21.7 degrees Celsius).

A cyclone's cooling effect on the ocean is critical to maintaining the oxygen level in the atmosphere. The plankton and algae living in the ocean can undergo photosynthesis if the water temperatures do not exceed about 80 degrees Fahrenheit (26.7 Celsius), and there is sufficient carbon dioxide to support photosynthesis. The oceans must not warm to the point of shutting down photosynthesis, nor should carbon dioxide emissions be restricted. Thus, the destruction of cyclones is not advisable. So, what can be done to minimize the damage from maritime storms while maintaining their beneficial cooling effect on the ocean?

### SUMMARY

This invention provides for affecting an atmospheric cyclone and quantifying parameters related to an affected atmospheric cyclone. Methods and apparatus in accordance with this invention involve attacking a cyclone chemically, without the use of explosives, with energy transfer inhibitors that interfere with the transmission of energy from the sea surface to the cyclone such that the energy of the cyclone is modified. Distribution of inhibitors into and/or onto the sea surface in the path of part of a cyclone can interfere with the evaporation of sea water to a part of the storm. The energy transfer inhibitors, if properly chosen and placed in the path of the storm, can deny the storm part of its energy source, the latent heat of vaporization of water. The part of the storm denied the latent heat of vaporization becomes energy and mass poor, creating an imbalance in the centrifugal force and mass of the storm. The imbalance in the centrifugal force can reduce the intensity of the storm and can be used to steer the storm.

In accordance with aspects of this invention, there is provided a method of affecting an atmospheric cyclone over a sea having a sea surface layer. The method includes distributing an energy transfer inhibitor into the sea surface layer at a location; and interfering with transfer of energy from the sea to the atmospheric cyclone, proximate to the location of an energy transfer inhibitor.

In accordance with aspects of this invention, there is provided a method of quantifying parameters for affecting an atmospheric cyclone. The method includes determining a reference value of an atmospheric cyclone parameter; where the atmospheric cyclone parameter represents an energy state of the atmospheric cyclone and is affected by an energy transfer inhibitor that interferes with energy transfer from a sea to the atmospheric cyclone; and determining a resultant value of the atmospheric cyclone parameter, including calculating an effect of the energy transfer inhibitor on the reference value of the atmospheric cyclone parameter, where the energy transfer inhibitor interferes with a latent heat of vaporization of water.

In accordance with aspects of this invention, there is provided an apparatus for quantifying a parameter for affecting an atmospheric cyclone. The apparatus includes an input/output device configured to receive and transmit data; a processor in communication with the input/output device configured to quantify the parameter based on data from the input/output device, where the parameter represents an energy state of the atmospheric cyclone and is affected by an energy transfer inhibitor that interferes with energy transfer from a sea to the atmospheric cyclone, and the processor is configured to determine a reference value of the parameter, and to determine a resultant value of the parameter based on an effect of the energy transfer inhibitor distributed into a sea surface layer at a location; and a memory in communication with the processor.

In accordance with aspects of this invention, there is provided a non-transitory computer readable storage medium having computer readable program code that, when executed by a computer, causes the computer to carry out a method of quantifying parameters for affecting an atmospheric cyclone. The method includes determining a reference value of an atmospheric cyclone parameter; where the atmospheric cyclone parameter represents an energy state of the atmospheric cyclone and is affected by an energy transfer inhibitor that interferes with energy transfer from a sea to the atmospheric cyclone; and determining a resultant value of the atmospheric cyclone parameter, including calculating an effect of the energy transfer inhibitor on the reference value of the atmospheric cyclone parameter, wherein the energy transfer inhibitor interferes with a latent heat of vaporization of water.

### BRIEF DESCRIPTION OF THE DRAWINGS

The several objects, features, and advantages of this invention will be understood by reading this description in conjunction with the drawings, in which;

FIG. 1 illustrates forces involved in affecting a cyclone, showing a solution of a vector diagram that takes into account example forces in a cyclone's environment;

FIG. 2 is a flow chart illustrating a method for affecting an atmospheric cyclone in accordance with this invention;

FIG. 3 is a flow chart illustrating a method for quantifying parameters for affecting an atmospheric cyclone; and

FIG. 4 is a block diagram illustrating a system for quantifying parameters for affecting an atmospheric cyclone.

### DETAILED DESCRIPTION

The destruction of cyclones is not advisable because of their enormous cooling effect on tropical and semitropical waters, which can be important for sustaining oxygen production by phytoplankton and algae. Current efforts for storm management include storm tracking and measurements, and costal preservation through the use of sand dunes, storm water drains, and related preparedness efforts. However, sand dunes do not stop a storm surge. Additionally, when the dunes are over-topped with storm surge, storm drains of sufficiently large capacity must be installed to move the water away from housing and other vulnerable infrastructure else another disaster will occur with the next cyclone that comes ashore.

A cyclone cannot create its own kinetic energy to produce the enormous power describe above. A storm can extract the random molecular kinetic energy from the latent heat of vaporization in the sea surroundings. It can then organize this liberated random molecular kinetic energy into rotational velocity, which originates in the low-pressure area of the tropical disturbance. The low-pressure area causes winds to flow inward. As the winds spiral upwards, the evaporation from the sea is carried aloft and condenses out as the adiabatic lapse rate cools the air at higher elevation.

There are constraints under which any weather system must operate in order to remain stable, to continue to liberate sufficient energy to maintain the eye and contact with the sea surface, and to replenish the air circulation around it.

A first constraint is that the weather system must strictly obey the laws of conservation of linear and angular momentum. In mathematical form, the product of system entrained mass (air mass plus water and vapor mass), times the system radius of gyration, times the angular velocity in radians per second, must equal a constant in order for the system to maintain itself. In other words:

M₁×R₁×ω₁=C=M₂×R₂×ω₂

in which M represents the cyclone's total mass, R represents the radius of gyration of the cyclone, ω represents the angular velocity of the cyclone in radians per second, and C represents the angular momentum. The subscripts represent the conditions before and after an event such as loss of a mass, such as water condensation, or loss of kinetic energy to the environment through friction with the sea, such as wave making. That means that every bit of angular momentum departing its system by loss of mass must be made up simultaneously with other mass picked up by the whirling winds from evaporation, and added to the total angular momentum inventory of the weather system so that the total remains constant or increases.

If there is a decrease in the angular momentum about the eye, there will be an immediate loss of angular velocity. This loss of velocity impedes the ability to evaporate water from the sea, because as wind velocity slows, the local pressure increases as per Bernoulli's law. This means the radius of gyration of the mass gets larger as the whirling circulation slows, allowing more mass to be lost through water condensation, in the form of rain.

This can be analogous to the spinning figure skater extending her arms to reduce or stop the spin, increasing her radius of gyration, or pulling her arms in close to her body to increase her spin, decreasing her radius of gyration. The local atmospheric pressure rises as velocity falls, in accordance with Bernoulli's law, and the eye begins to unbalance and wobble by continuing to shed its massive supply of water. This phenomenon has been witnessed at the end of a cyclone's life while in contact with the land, as the eye of the cyclone becomes more disorganized and wind velocity decreases, downgrading the cyclone into tropical storm status. The portion of the cyclone over land does not extract sufficient energy from evaporation from the earth to maintain its energy content and the system begins to collapse.

The energy addition from the evaporation of sea water to the storm occurs about equally in all sectors of the storm. The inventor has recognized that interference with evaporation to one part of the storm, while allowing unimpeded evaporation to the remaining part of the storm, can induce a mass imbalance to occur, and with that a force imbalance. This is because the centrifugal force of the massive side of the storm would be much larger than the less massive side, and the net force exerts a pressure on the massive side. The imbalance of the centrifugal force then pulls the storm towards the massive side and away from the less massive side. If an efficient evaporation inhibitor were introduced on the sea, directly in the path of the cyclone, the effect on the storm would be to accelerate the storm in the opposite direction of its path. This can stall the storm's forward motion from its steering currents and diminish the intensity of the storm, at first in the less massive part of the cyclone and then, as the evaporation inhibitor is carried around to the other parts of the cyclone, by circulation. The overall effect can be halting the storm's forward motion and reducing its energy supply, causing a loss of angular and linear momentum.

Thus, the thermodynamic effects of introducing these energy transfer inhibitors into the cyclone include inhibition of local water vaporization and reduced energy extraction from the latent heat of vaporization. This leads to reduced angular velocity at the surface and a rising barometric pressure in the eye. The cyclone becomes energy poor, where its mass and intensity are reduced. It is understood that cyclone intensity can be affected by interfering with the transfer of energy to the cyclone. By selectively inhibiting evaporation in one part of the storm to induce an imbalance in the centrifugal force, the cyclone's path can be affected.

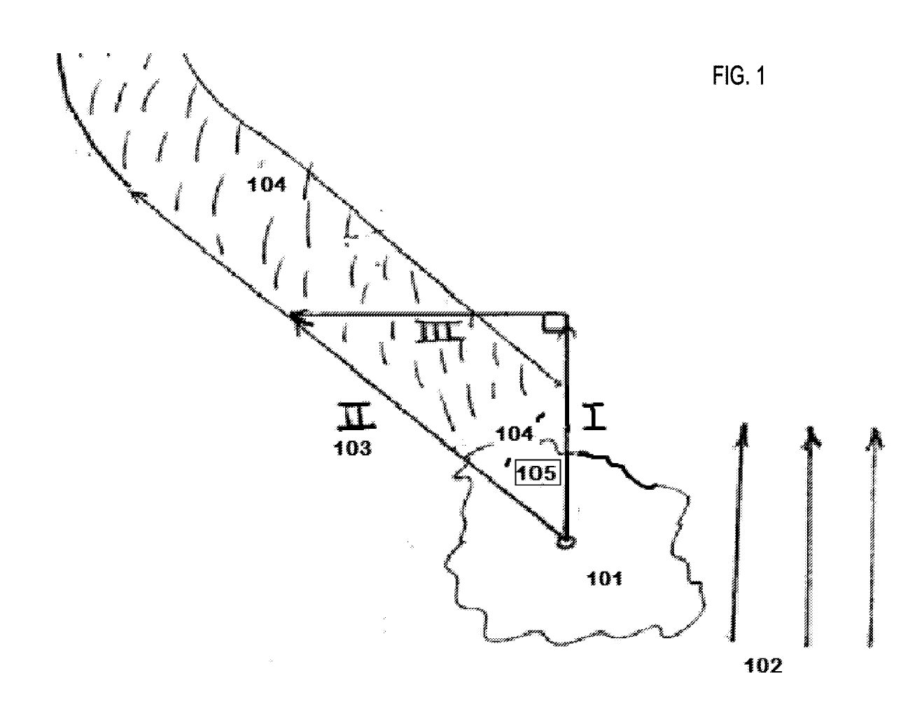

FIG. 1 illustrates forces involved in affecting a cyclone, showing a solution of a vector diagram that takes into account example forces in a cyclone's environment. The artisan will understand that Vectors I, II, and III can represent any parameter that represents the energy of an atmospheric cyclone, e.g. velocity, acceleration, etc. The cyclone (101) can be influenced by forces (102), which can include, for example, ocean currents that influence a hurricane's path through surface friction coupling forces up into the storm, wind currents aloft arising from jet stream movements, wind from local fronts interacting with local highs and lows, and terrestrial rotation. A desired path (103) of the cyclone can be achieved by distributing energy transfer inhibitors in a treatment area (104), under the eye of the cyclone and along its path. The energy transfer inhibitors are distributed by a distributer (105), which can include, for example, a device configured to deliver the energy transfer inhibitors onto or into the sea surface layer. The device can be onboard a vessel, aircraft, or located on land.

For example, if a cyclone has been following a more or less constant heading for a period of time, e.g. north at 18.5 km/h, the vector diagram construction can start with a vector on the same heading, with the length of the vector scaled to the speed of advance of the storm. In FIG. 1, such a vector can be Vector I. For this example, it can be assumed that the path is the resultant of the existing currents (102) and the path would hold steady at least for the duration of a treatment period, e.g. about 6 hours. The treatment period can be the period of time during which energy transfer, etc., is reduced by an effective amount, e.g. 50%. The artisan will understand that the one or more energy transfer inhibitors can continue to be effective as long as the energy transfer inhibitors can interfere with the vaporization of water. Emanating from the origin of Vector I, a second desired vector, Vector II, can be drawn on the heading of the desired path of the storm, but the second vector has an undetermined length. Finally, a third vector, Vector III, emanating from the head of Vector I, is determined that is perpendicular to Vector I and contacts Vector II. Thus, the length of Vector III is determined by its intersection with Vector II. Vector II represents the desired path of the storm at a speed computed as illustrated in FIG. 1.

A submarine or other energy transfer inhibitor distributer (105) treats the sea ahead of the storm, for example in 50 mile (80.5 kilometers) increments, resolving the vector diagram as each portion of the path is traversed by the storm and reselecting the area ahead of the storm for treatment to keep the storm on the desired path. Each new vector diagram would reflect changes in the cyclone's path.

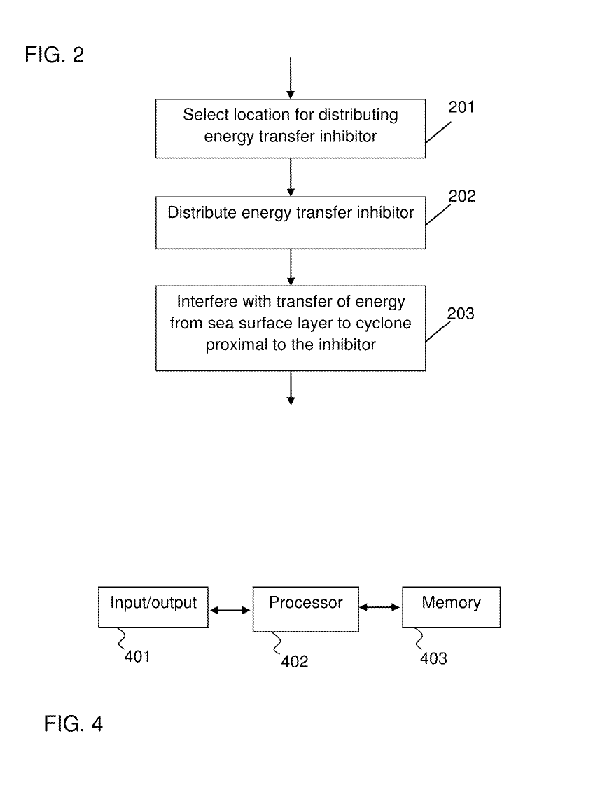

FIG. 2 is a flow chart illustrating an example of a method for affecting an atmospheric cyclone in accordance with this invention. It will be understood that other methods in accordance with this invention can have more or fewer steps, as determined by the appended claims.

In step 201, a location (104) for energy transfer inhibitor distribution is selected. In this step, a location is selected based on thermodynamic principles governing the atmospheric cyclone. The energy source for an atmospheric cyclone resides in the thermodynamic disequilibrium between the atmosphere and the ocean, where the evaporation of water transfers latent heat energy from the ocean into the atmosphere. The atmospheric cyclone contains a low pressure center where surface winds, loaded with energy rich water vapor, are drawn into the eye of the cyclone. Thus, the locations where the surface winds extract the latent heat energy from the sea surface through the evaporation of water are among the locations contemplated for energy transfer inhibitor distribution.

The locations selected for energy transfer inhibitor distribution can be within the radius of the cyclone and along the cyclone's path. The path of the cyclone can be the path determined by weather forecasting methods, as used by persons having ordinary skill in the art. The vector, Vector I, can begin under the storm's eyewall and continue in the direction of the forward path of the atmospheric cyclone. Energy transfer inhibitor distribution can be along Vector I, and encompass the area to the desired path, Vector II.

In step 202, the energy transfer inhibitors are distributed into the sea surface layer, where the sea surface layer can include at least one of the sea surface and ocean mixing layers. The artisan will understand that into the sea surface layer means into and onto the sea surface layer. The one or more energy transfer inhibitors are distributed, thereby covering a geographic area that can be similar in size to the footprint of the atmospheric cyclone. The energy transfer inhibitors can be infused into the sea surface layer through the use of an aircraft, watercraft, or from a distributor located on land. By way of non-limiting example, a submarine can be utilized, where a submarine's tanks can be filled with energy transfer inhibitors and the energy transfer inhibitors released into the sea surface layer. The ship's installed instruments can be used to monitor the location of the storm, the storm metrics, the surface winds and waves, and the forecasted storm track vector, Vector I. The advantage of using a submarine to distribute the one or more energy transfer inhibitors is the ability of the submarine to get close to the storm and be relatively unaffected by the difficult atmospheric and sea conditions proximal to the cyclone. A nuclear submarine can be the safest and least costly manner to distribute the energy transfer inhibitors, as the submarine can maneuver under storms and communicate with government agencies charged with the responsibilities of storm management.

In step 203, the one or more of the energy transfer inhibitors on and in the sea surface layer act to interfere with transfer of energy from the ocean to the atmospheric cyclone. The one or more energy transfer inhibitors form a monolayer, a bilayer, an emulsion, become a heterogeneous mixture with seawater, or any combination of these intermolecular arrangements. The energy transfer inhibitor-water interactions are formed on and in the sea surface layer. The one or more energy transfer inhibitors can act as a physical chemical barrier to sea water evaporation, increase the intermolecular interactions with water through hydrogen bonding, alter the vapor pressure of water, or act by any other means to interfere with the transition of water to vapor. By suppressing this transition, the one or more energy transfer inhibitors impede the transfer of latent heat energy from the ocean to the atmospheric cyclone. In other words, the energy-rich water molecules remain on and in the sea surface layer, instead of vaporizing into the surface winds of that part of the cyclone. The surface winds can then contain few water molecules and would be mass and energy poor.

The devices and energy transfer inhibitors required to accomplish the above can include, for example, submarines releasing streams of energy transfer inhibitors onto the sea surface in front of part of the cyclone between Vectors I and II. By way of non-limiting example, energy transfer inhibitors can include long chain fatty acids, esters, alcohols, and waxes. For example, an energy transfer inhibitor mixture including a 50 percent mixture of soybean oil and decanoic acid can be released at a rate of 100 gallons per square mile of seascape for a category 1 hurricane. Decanoic acid and soybean oil are fatty acids with long hydrocarbon chains that can act as solvents, and readily hydrogen-bond with water using a carboxylic acid group located at one end of the carbon chain. This hydrogen bond can temporarily anchor water molecules to the energy transfer inhibitors, inhibiting water vaporization. In another example, an evaporative inhibitor can include chemicals secreted from plants, e.g. lobelia telekii.

By way of non-limiting example, a submarine submerged to 150 feet (45.7 meters) below a cyclone can release 5000 gallons (18,927 liters) of energy transfer inhibitors from one or more of its tanks which can cover about 50 square miles (129.5 square kilometers) of a storm's hemisphere per application. As wind and wave action tend to break up the intermolecular arrangements, the submarine below can distribute the energy transfer inhibitors to replenish the energy transfer inhibitors for a long enough time to cause the desired change of path. The submarine or other distributer (105) can carry a sufficient amount of energy transfer inhibitors in its tanks to maintain the intermolecular arrangements for an extended period if necessary.

The mass and energy-poor winds disrupt the energy supply of the cyclone, creating an imbalance in the cyclone and affecting the cyclone's intensity. As the mass and energy-poor winds are drawn into the low pressure center of the cyclone, there is a decrease in the angular momentum of the forward part of the cyclone. The reduced mass and angular momentum of this part of the cyclone can cause a mass imbalance in the cyclone. The storm winds circulating in the area of inhibitors cannot evaporate as much seawater and can cause a mass deficit.

The imbalance in the atmospheric cyclone can cause the intensity of the cyclone to be reduced, and the cyclone can be steered. The infusion of energy transfer inhibitors onto the sea surface in the path of the low pressure system inhibits evaporation of sea water, affecting the energy production rate and the cyclone's intensity. This can cause an angular momentum deficit of the cyclone and acceleration toward the more massive part of the cyclone. By selectively introducing the energy transfer inhibitors into a part of the cyclone, that part's contribution to the system's total energy production and angular momentum is decreased. This decrement of energy and entrained water vapor create a mass imbalance in the system, which causes the eye to accelerate towards the massive and energetic side of the system from the imbalance of the centrifugal forces acting on the eye and system as a whole. Interference with the transmission of upward angular momentum, which allows the system as a whole to maintain itself, allows for the system intensity and direction to be controlled. In other words, the infused energy transfer inhibitors into and onto the sea surface cause an imbalance in the cyclone and alter the path, intensity, or both.

If sufficient energy production shut down and slowing of the rotational velocity transmission is accomplished, that part of the cyclone will have reduced rotational velocity and entrained water mass. Much less mass will be inducted in that part of the cyclone, causing an unbalanced centrifugal force to be exerted on the system. The eye can be pulled towards the heavier, more massive side of the storm, thus altering the path of the storm so long as treatment of the seawater is maintained as described. As the cyclone moves into untreated waters, the original path of the cyclone can be resumed so long as the currents of the atmosphere remained as before. With experience gained by affecting cyclones, it is possible to treat the waters ahead of the storm in a curved line to induce a more radical change in the path toward a more favorable direction, away from land and towards ocean hot spots.

Thus, for a mid-Atlantic cyclone moving westward, a right turn to the north of the storm's path can be induced by placing and maintaining a line of evaporative inhibitors initially on the south side of the projected path of the eye, and then curving the path around to the western side, causing an imbalance of mass and angular momentum to pull the system to the north and change its path to carry it away from the Caribbean islands.

By way of non limiting example, if a hurricane such as Isaac is bearing down on a coastal city in the northern hemisphere, a line of energy transfer inhibitors can be placed on the water directly in front of the storm beginning at three o'clock relative to the storm's heading so that the counterclockwise rotation would assist in infusing the energy transfer inhibitors around to nine o'clock at right angles to the hurricane's movement on the forward hemisphere of the hurricane. The energy transfer inhibitors would cause the forward part of the hurricane to lose mass and energy, accelerating the eye in the opposite direction of movement. This would tend to initially stall the storm in its forward motion, which causes it to re-evaporate the same water condensed out as rain, making it more difficult to extract the latent heat as an energy source due to reduced vapor pressure from lower temperatures on the surface and the increase of entropy in the system reducing the available energy yield from evaporation. This would reduce the energy production rate and control the rate of storm expansion. Continuing this treatment by blocking the storm's movement can lead to the storm's demise.

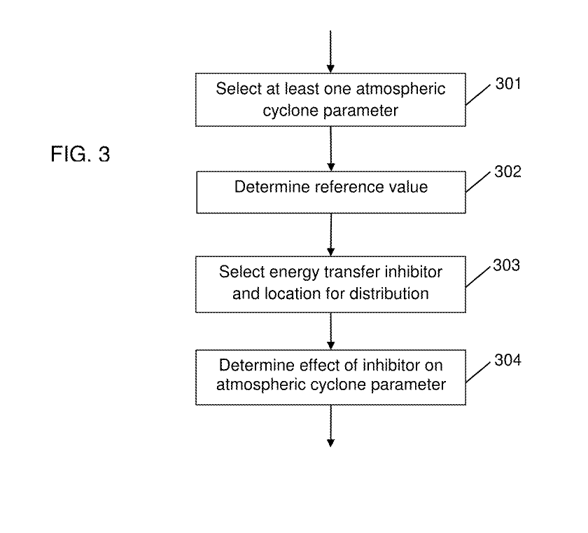

FIG. 3 is a flow chart illustrating a method for quantifying parameters for affecting an atmospheric cyclone. It will be understood that other methods in accordance with this invention can have more or fewer steps, as determined by the appended claims.

In step 301, at least one atmospheric cyclone parameter is selected that represents at least one of a cyclone's energy state, path, or intensity. For example, the at least one parameter selected can be related to the force of a cyclone that incorporates, for example, surface winds, air convection currents, ocean thermal mixing currents, bulk aerodynamic flux formulas that model the cyclone's eye and vortex characteristics, an equivalent, or any combination thereof. Other parameters used by a person skilled in the art can also be used. For example, the steering force of the cyclone can be selected, where the magnitude of the steering force generated can be estimated by computing the centrifugal forces on opposite sides of the cyclone when only one hemisphere is fully engaged in evaporating water while the other side is inhibited from evaporation by the energy transfer inhibitors. For illustrative purposes, Vector I in FIG. 1 can represent the eye acceleration vector of the cyclone before treatment, and Vector III can represent the eye acceleration vector of the cyclone during treatment, as one side of the cyclone is inhibited from evaporating water. Steering force can be obtained by multiplying the eye acceleration vector by the cyclone's mass. Eye velocity can be obtained by integrating the eye acceleration vector over time, and eye acceleration can be obtained by differentiating the eye velocity vector with respect to time.

In step 302, a reference value of the at least one atmospheric cyclone parameter is determined. For example, if steering force is selected, the centrifugal force of the cyclone can be determined by first obtaining the centrifugal acceleration and mass of the cyclone. The average centrifugal acceleration is velocity squared, V², divided by the radius of gyration, R. In other words:

a_{c}=V²/R

The radius of gyration, R, of a cyclone is computed by taking the square root of the quantity of the polar moment of inertia at the surface, axis perpendicular to the surface through the storm's eye, divided by the core area of the storm at the surface. In other words, the radius of gyration, R, for circular shapes is:

R=(I/A)^{1/2}=(π/2 r⁴/πr²)^{1/2}=r/√2

where I represents the polar moment of inertia, A represents the cross-sectional area of the cyclone, and r represents the radius of the cyclone. The mass of the cylindrical storm can be calculated using the formula:

m=ρ×π×r²×h

where m represents mass of the cyclone, ρ is the density, r is the radius of the cyclone, and h is the height of the cyclone.

For example, consider a storm that is (a) evaporating 100,000 lbs per second from one side and 50,000 lbs per second from the inhibited side, (b) raining at the same rate as evaporating so that the mass of the storm remains constant, (c) rotating about the eye at an average velocity, V, of 75 miles per hour (110 ft/sec) at the storm's radius of gyration, and (d) the core of the storm covers 1000 square miles such that the storm radius is 17.84 miles (28.71 or kilometers). The storm's core radius of gyration is:

R=28.71/2^{1/2}=20.3 kilometers.

The mass of the storm's hemisphere on the untreated side is estimated by the storm's volume enclosing a 1000 square mile circular area by a 5000 foot high cylindrical volume and then dividing this volume in half. The hemi-cylindrical volume is then (1000×5280²×5000)/2=69,696,000,000,000 ft³ or 1,973,790,720,000 m³. From a psychrometric chart of air-water mixtures at 1 atmosphere and 75 degrees F. dry-bulb and 100% relative humidity, the ratio of water vapor mass to air mass is 0.0270. From Steam Tables, the weight density of dry air at 1 atmosphere and 75 degrees is 0.0743 lbs/ft³. The weight of dry air in the hemi-cylinder is (0.0743)×(69,696)×10⁹=5,178.41×10⁹ lbs. The mass of dry air in the hemi-cylinder is (5,178.41×10⁹/32.2) slugs=160.82×10⁹ slugs. The mass of water vapor entrained in the mass of dry air to bring the air-water vapor mixture up to 100% relative humidity is the mass of dry air in the hemi-cylinder times the ratio of the mass of water vapor to the mass of dry air from the psychrometric chart, 0.0270 slugs of water vapor/cubic foot/slugs of dry air/cubic foot, or 0.0270×160.82×10⁹+160.82×10⁹=165.16×10⁹ slugs of air-water vapor mass in the hemi-cylinder.

In addition to the air and water vapor mass there is entrained water condensed out as rain and spray, estimated at 10 per cent of the air water vapor mass, which must be included to obtain an estimate of the total mass of the hemi-cylinder. Since it is assumed that the storm is raining at the same rate as evaporating, i.e. not gaining or losing mass, the total mass of the hemi-cylinder is the masses of air, water vapor and air borne water=165.16×10⁹+0.10×165.16×10⁹=181.67×10⁹ slugs having a weight of 260.00×10¹¹ newtons.

Thus, the average centrifugal acceleration acting on the system is V²/R=110²/(66601)=0.181 ft/sec² (0.055 m/sec²). Since the storm's hemi-cylinder total mass is estimated up to 5000 feet and the average centrifugal acceleration is known, the centrifugal force acting on the hemi-cylinder through the centroid of the hemi-cylinder can be calculated from F=ma as 181.67×10⁹ slugs×0.181 ft/sec²=32.88×10⁹ lbs (146.3×10⁹ Newtons). The pressure of this force per square foot acting uniformly on the hemi-cylinderic cross sectional area is 32.88×10⁹/(35.68×5280×5000)=34.90 lbs per square foot (1671 Pa). By comparison, a Category 3 hurricane at 130 mph (190.6 ft/sec) of the same mass and 1000 square mile area would experience 90.15 pounds per square foot pressure from the centrifugal force imbalance (4316 Pa).

In step 303, the at least one energy transfer inhibitor and the at least one location for distribution is selected. The at least one energy transfer inhibitor can be selected based on its ability to interfere with the evaporation of water from the sea. The at least one energy transfer inhibitor that can affect the latent heat of vaporization of sea water is distributed within the radius of the cyclone and along the cyclone's path. The path of the cyclone can be the path determined, for example, by weather forecasting methods as used by persons having ordinary skill in the art.

In step 304, the effect of the at least one infused energy transfer inhibitors on the at least one atmospheric cyclone parameter is calculated. For example, if steering force is selected, the effect of the energy transfer inhibitors on the cyclone's steering force can be calculated by multiplying the eye acceleration vector, Vector III, by the mass of the affected cyclone. The amount of energy transferred to the cyclone can also be estimated by measuring the mole fraction of water vapor above the energy transfer inhibitor treated area, multiplied by the latent heat of vaporization of water, multiplied by the mass of the air. Other mathematical algorithms used by a person skilled in the art can include vapor pressure, temperature, volume, or other parameters. The energy and dry air mass can be used to calculate the imbalance of the cyclone, so that intensity, path or energy state can be forecast.

Where steering force is selected, assume, for example, the hemi-cylinder of the cyclone that circulates over the inhibitor treated waters can evaporate only half of the water mass and can rapidly lose energy and sheds mass, that hemi-cylinder quickly loses the ability to counter the centrifugal pull of the untreated hemi-cylinder. Turbulent chaotic reactions develop which slow the angular velocity, initially ovalizing the eye with the long axis in the direction of the eye's acceleration, and further reducing the opposing centrifugal forces. The eye can then be expected to become pear shaped as the radius of gyration would increase in the treated portion of the eye as that portion slows down. Suffice it to say that the opposing centrifugal force would be at most half of the untreated hemi-cylindrical centrifugal force, which would produce half of the acceleration of the untreated hemisphere acting in the opposite direction. In this example, the centrifugal acceleration of the inhibitor-treated hemisphere would be no more than 0.181/2=0.0905 ft/sec² (0.028 meters/sec²).

A resultant atmospheric cyclone parameter is calculated, such that the steered cyclone's energy state, path, or intensity can be forecast. One or more parameters can be vectorially added or weighted to provide a range of effects on the resultant atmospheric cyclone prediction vector. In the above example where steering force is selected, integration of the acceleration vector over a 2 minute period, to form a resulting velocity vector, yields 0.0905 ft/sec²×120 sec=10.86 ft/sec (3.3 meters/sec). In other words:

∫₀¹²⁰ V(t)=0.0905 dt=10.86 ft/sec (3.3 meters/sec)

This vector acting at right angles can be added to the storm's path and speed vector, along with the existing current velocity vector to produce the resultant path and speed velocity vector of the storm. In this example, two minutes was chosen as a best estimate of the maximum time interval for integration because the acceleration would be opposed by surface friction build-up, which would limit the total velocity attainable by the unbalanced centrifugal forces acting on the storm just as the velocity of the storm from the environmental currents is also limited. Thus, by integrating the acceleration vector to a velocity vector, the steering effect of the infused energy transfer inhibitors upon the cyclone is quantified.

The resultant vector can then be used to forecast the cyclone's altered energy state, path, intensity, or any combination thereof. This resultant vector can be chosen to carry the storm away from land masses or towards ocean hot spots which are threatening the vital photosynthesis function of the marine ecosystem. The solution to the vector diagram that can result from placing the path and speed vector on a standard marine maneuvering board, selecting a desired path and closing the vector triangle with the storm's eye acceleration vector drawn at right angles to the storm's path and speed vector, can yield the solution and inform the user what portion of the cyclone to treat in order to drive the storm onto the desired path.

The cyclone's forecast path can be evaluated for additional steering. Iteration of the vector diagram as tracking data comes available after the initial treatment can provide steering and treatment corrections as the storm proceeds.

FIG. 4 is a block diagram illustrating an apparatus (400) for quantifying parameters for affecting an atmospheric cyclone. Such an apparatus (400) can implement the methods illustrated by FIG. 3 and other figures described above. It will be understood that other systems in accordance with this invention can have more or fewer components, as determined by the appended claims.

The apparatus (400) includes an input/output communication device (401), such as a keyboard, pointing device, display, and other devices that communicates with a processor (402) and a memory (403). The input/output device (401) can be configured to receive and transmit any form of data, for example, data obtained from a marine maneuvering board, from the U.S. National Oceanic and Atmospheric Administration, and or from other sources. For example, the input/output device (401) can be configured to supply a selected atmospheric parameter or other data to the processor (402). The memory (403) communicates with the processor at least, and can be configured to store and retrieve information, e.g., program instructions executed by the processor (402), data used and generated by the processor (402), input/output data, and other management instructions. The memory can be any suitable type of computer-readable memory of volatile or non-volatile type.

The processor (402) can be a suitably programmed electronic processor, e.g., a microprocessor, digital signal processor, field programmable gate array (FPGA) application specific integrated circuit (ASIC), or other form of processing circuitry. It should be appreciated the processor (402) need not be a single unit, but can be comprised of any number of units.

For example, the processor (402) can be configured by suitable programming to determine a reference value of a parameter that represents an energy state of an atmospheric cyclone and that is affected by an energy transfer inhibitor that interferes with energy transfer from a sea to the atmospheric cyclone. The processor (402) can be further configured by suitable programming to determine a resultant value of the parameter. For example, the processor (402) can be configured to calculate an effect of the energy transfer inhibitor distributed into the sea surface layer at a location on the latent heat of vaporization of water, the mole fraction of water vapor proximate to the distributed energy transfer inhibitors, or other energy transfer parameter. Typically, the processor (402) is configured to calculate the effect of an energy transfer inhibitor on a cyclone parameter using a mathematical equation, algorithm, or other relationship. For example, the processor (402) can be configured to calculate the effect of the at least one energy transfer inhibitor upon the mass or centrifugal force of the cyclone, steering force, or other parameter. The processor can be configured to calculate the cyclone's energy, path, intensity, or any combination thereof.

The apparatus (400) can be used for quantifying at least one parameter related to affecting an atmospheric cyclone as described above by configuring the processor (402) to estimate a resultant atmospheric cyclone parameter, repeatedly if desired. The processor (402) can be configured to generate a forecast of the parameter, such as the cyclone's energy state, path, and intensity, based on the resultant value. Moreover, the processor (402) can be configured to evaluate the energy state, path, and intensity forecast to determine whether to distribute additional energy transfer inhibitor based on a calculated effect of distributing the additional energy transfer inhibitor. Thus, the cyclone's energy, path, intensity, or any combination thereof, can be evaluated for additional steering. If additional steering is desired, the processor can be configured to iteratively calculate the resultant parameter.

For example, the movement of the eye can be tracked by a submarine and controlled through the introduction of additional energy transfer inhibitors taking into account any steering air currents aloft. For example, the storm's path can be, for example, Vector I, calculated from nature's steering currents (102), a prediction model vector, for example, supplied by the National Oceanic and Atmospheric Administration, or a resultant vector, Vector II, calculated from the method for affecting an atmospheric cyclone as described in FIG. 2 and FIG. 3. For example, initially, Vector III can be perpendicular to Vector I, in the direction of the desired path of the cyclone. With subsequent steering force corrections, Vector III for example, can be further adjusted to bring the final resultant path of the cyclone, for example, Vector I, onto the desired path of the cyclone, for example, Vector II.

After control of the atmospheric cyclone is established, the atmospheric cyclone can be steered away from population centers and then ushered ashore in a weakened state to feed drought areas. Cyclones can also be steered towards superheated areas of the oceans to assist in maintaining productive colonies of plankton and algae, to prevent an atmospheric oxygen deficit resulting from global population growth and economic development. By directing cyclones into the ocean hot spots, more favorable weather climates for farming can created in arid countries around the world. This effort can be among the first of a series of weather engineering actions that can lead to agricultural climate improvement and economic self-sufficiency, particularly among emerging nations. For example, by applying energy transfer inhibitors along the horn of the Africa coast, many of the cyclone systems coming west into the Atlantic Ocean can be blocked from ever getting to sea. The moisture entrained in these systems can remain on the continent and increase rainfall in the area. This can reduce the number of cyclones formed in that part of the Atlantic, many of which migrate into the Caribbean islands and beyond.

Advantages of this approach include relatively low cost, increased public safety, reliance on existing technologies, and peaceful use of nuclear power to benefit all maritime countries. In addition, the inhibitors used can be nonpolluting, and be readily variable and capable of rapid deployment to determine the optimal most effective mix. The energy transfer inhibitors can be stored in separate tanks and mixed together via the submarine's piping system to produce a variety of mixtures, which can be released to sea to aid in discovering which mixture is most effective for the particular storm being treated.

It is expected that this invention can be implemented in a wide variety of ways, that the methods and devices described above can be combined and re-arranged in a variety of equivalent ways, and that the methods can be performed by one or more suitable electronic circuits (e.g., discrete logic gates interconnected to perform a specialized function, or application-specific integrated circuits). It will be appreciated that procedures described above are carried out repetitively as necessary. To facilitate understanding, aspects of the invention are described in terms of actions that can be performed by, for example, elements of a programmable computer system or by specialized circuits, by program instructions executed by one or more processors, or by a combination of both.

Moreover, this invention can additionally be considered to be embodied entirely within any form of computer-readable storage medium having stored therein an appropriate set of instructions for use by or in connection with an instruction-execution system, apparatus, or device, such as a computer-based system, processor-containing system, or other system that can fetch instructions from a storage medium and execute the instructions. As used here, a “computer-readable medium” can be any means that can contain, store, or transport the program for use by or in connection with the instruction-execution system, apparatus, or device. The computer-readable medium can be, for example but not limited to, an electronic, magnetic, optical, electromagnetic, infrared, or semiconductor system, apparatus, or device. More specific examples (a non-exhaustive list) of the computer-readable medium include an electrical connection having one or more wires, a portable computer diskette, a random-access memory (RAM), a read-only memory (ROM), an erasable programmable read-only memory (EPROM or Flash memory), and an optical fiber.

Thus, the invention may be embodied in many different forms, not all of which are described above, and all such forms are contemplated to be within the scope of the invention. It is emphasized that the terms “comprises” and “comprising”, when used in this application, specify the presence of stated features, steps, or components and do not preclude the presence or addition of one or more other features, steps, components, or groups thereof.

The particular embodiments described above are merely illustrative and should not be considered restrictive in any way. The scope of the invention is determined by the following claims, and all variations and equivalents that fall within the range of the claims are intended to be embraced therein.

1. A method of affecting an atmospheric cyclone over a sea having a sea surface layer, comprising:
distributing an energy transfer inhibitor into the sea surface layer at a location; and
interfering with a transfer of energy from the sea to a portion of the atmospheric cyclone, proximate to the location of an energy transfer inhibitor, wherein the enemy transfer inhibitor modifies a vapor pressure of water such that the transfer of enemy from the sea to a portion of the atmospheric cyclone is reduced.

2. The method of claim 1, whereby an angular momentum of the atmospheric cyclone is modified.

3. The method of claim 1, wherein a centrifugal force imbalance within the atmospheric cyclone is created.

4. The method of claim 1, wherein the energy transfer inhibitor modifies an intensity or a path of the atmospheric cyclone.

5. The method of claim 1, wherein the energy transfer inhibitor is distributed from a watercraft, aircraft, a location on land, or any combination thereof.

6. The method of claim 2, wherein the energy transfer inhibitor is selected from a group that includes long-chain fatty acids, esters, alcohols, and waxes.

7. The method of claim 6, wherein the energy transfer inhibitor includes a mixture of decanoic acid and soybean oil.

8. A method of quantifying parameters for affecting an atmospheric cyclone, comprising:
determining a reference value of an atmospheric cyclone parameter; wherein the atmospheric cyclone parameter represents an energy state of the atmospheric cyclone and is affected by an energy transfer inhibitor that interferes with energy transfer from a sea to a portion of the atmospheric cyclone; and
determining a resultant value of the atmospheric cyclone parameter, including calculating an effect of the energy transfer inhibitor on the reference value of the atmospheric cyclone parameter, whereby an angular momentum of the atmospheric cyclone is modified.

9. The method of claim 8, wherein the atmospheric cyclone parameter includes a steering force correlated to a centrifugal force imbalance within the atmospheric cyclone.

10. The method of claim 8, further comprising forecasting at least one of the energy state, a path of the atmospheric cyclone, and an intensity of the atmospheric cyclone based on the resultant value.

11. The method of claim 10, further comprising evaluating at least one of the forecast energy state, path, and intensity forecast to determine whether to distribute additional energy transfer inhibitor based on a calculated effect of distributing the additional energy transfer inhibitor.

12. An apparatus for quantifying a parameter for affecting an atmospheric cyclone, comprising:
an input/output device configured to receive and transmit data;
a processor in communication with the input/output device configured to quantify the parameter based on data from the input/output device, wherein the parameter represents an energy state of the atmospheric cyclone and is affected by an energy transfer inhibitor that interferes with energy transfer from a sea to the atmospheric cyclone, whereby an angular momentum of the atmospheric cyclone is modified; and
the processor is configured to determine a reference value of the parameter, and to determine a resultant value of the parameter based on an effect of the energy transfer inhibitor distributed into a sea surface layer at a location; and
a memory in communication with the processor.

13. The apparatus of claim 12, wherein the processor is configured to generate a forecast of the parameter based on the resultant value, and the parameter includes at least one of the cyclone's energy state, path, and intensity.

14. The apparatus of claims 13, wherein the processor is configured to evaluate the forecast to determine whether to distribute additional energy transfer inhibitor based on a calculated effect of distributing the additional energy transfer inhibitor.

15. A non-transitory computer readable storage medium having computer readable program code that, when executed by a computer, causes the computer to carry out a method of quantifying parameters for affecting an atmospheric cyclone, wherein the method includes:
determining a reference value of an atmospheric cyclone parameter; wherein the atmospheric cyclone parameter represents an energy state of the atmospheric cyclone and is affected by an energy transfer inhibitor that interferes with energy transfer from a sea to the atmospheric cyclone, whereby an angular momentum of the atmospheric cyclone is modified; and
determining a resultant value of the atmospheric cyclone parameter, including calculating an effect of the energy transfer inhibitor on the reference value of the atmospheric cyclone parameter, wherein the energy transfer inhibitor interferes with a latent heat of vaporization of water.
